(19) United States
(12) Patent Application Publication
(10) Pub. No.: US 2022/0315487 A1
(43) Pub. Date: Oct. 6, 2022

(54) METHOD AND PLANT FOR MANUFACTURING GRANULATE MATERIALS DESIGNED TO BE USED FOR MANUFACTURING ARTICLES IN FORM OF SLAB OR BLOCK FROM A MIXTURE

(71) Applicant: Luca Toncelli, Bassano del Grappa (VI) (IT)

(72) Inventor: Luca Toncelli, Bassano del Grappa (VI) (IT)

(21) Appl. No.: 17/640,268

(22) PCT Filed: Sep. 9, 2020
(86) PCT No.: PCT/IB2020/058363

§ 371 Date: Mar. 3, 2022

(30) Foreign Application Priority Data
Sep. 11, 2019 (IT) 102019000016043

(51) Int. Cl. C04B 14/04; C04B 14/30; C04B 20/02; C04B 20/04

(52) U.S. Cl. CPC C04B 14/041; C04B 14/303; C04B 14/304; C04B 20/026; C04B 20/04; C04B 2290/00

(57) ABSTRACT

Method for the production of granulate materials designed to be used for manufacturing articles in slab or block form from a mixture. The method comprises the steps of a) melting a mixture of selected minerals having a specific chemical composition for obtaining a casting of molten material, c) cooling the cast material until a predetermined temperature is reached and d) crushing and/or grinding the material to obtain granules having a selected grain size and suitable for use respectively as aggregates or fillers in the mixture for manufacture of the articles. Moreover, the method comprises, downstream of the melting and casting step a), a step b) of keeping the molten and cooled material at a temperature of between 1030-1170° C. for a predetermined time period of at least 15 minutes. The granulate materials thus obtained have a content of silicon dioxide in crystalline form of less than 1%. The invention also relates to a plant for the production of granulate materials suitable for use as aggregates or fillers for the manufacture of articles in slab or block form.

The present invention relates to a method for the production of granulate materials intended to be used, in the form of aggregates or fillers, for manufacturing articles in slab or block form from a mixture.

In particular, the granulate materials obtained by means of the method of the present invention are formed mainly by calcium silicates substantially free from silicon dioxide in crystalline form, namely with a content of silicon dioxide in crystalline form of less than 1%. Moreover, the aggregates and fillers have a stone or stone-like aspect and the mixture used to produce the articles in slab or block form comprises, in addition to the aggregates and fillers, also an organic or inorganic hardening binder.

The invention also relates to a plant for the production of the granulate materials which uses the aforementioned method.

The articles produced from a mixture may be made, in a manner known per se, by means of rolling, pressing, extrusion or for example by means of a procedure known also as Bretonstone® technology.

In this procedure, a mixture formed by granulate stone or stone-like material, a filler and a binder, for example a hardening resin, is initially poured into a temporary support or mould; then the mixture is subjected to vibration with simultaneous pressing or compression under a vacuum (vacuum vibrocompression) and then hardening of the mixture is performed.

The aggregates normally consist of natural minerals which may be of a siliceous nature, such as quartz, cristobalite, granites, porphides, basalt, quartzites, or of a calcareous nature, such as marbles, dolomites and coloured stones.

Fillers are materials used in combination with the binder to form the so-called binding paste and normally consist of stone materials in powder form of varying kinds, such as ventilated quartz or ventilated feldspar in combination with siliceous aggregates or calcium carbonate, or aluminium hydroxide in combination with calcareous aggregates.

The mixture may also comprise additives and colouring agents for obtaining articles which have special aesthetic effects, for example veining.

Among the various types of materials used to produce the aggregates and fillers, ground quartz, in the form of sand and fine powder respectively, are commercially distributed widely within the sector.

In fact, owing to the transparency of the quartz, it is possible to obtain articles which have a very attractive appearance, are extremely scratch-resistant and/or abrasion-resistant and are resistant to chemical agents such as acids which are commonly used.

Alternatively, when it is required to manufacture articles with a deep white colour, granulate materials and fillers composed of cristobalite—a mineral polymorph of quartz in crystalline form—are currently used.

Cristobalite is opaque and has a deep white colour; moreover, during the production of these articles, a step of adding a white pigment may be provided.

Despite the fact that they are widely used, these applications are not without a number of drawbacks.

For example, one drawback with particularly serious consequences in the sector is the fact the use of materials such as quartz, cristobalite, quartzites or siliceous sands for the manufacture of the aggregates and fillers results in the formation of crystalline silicon dioxide (SiO₂) dust during manufacture of the article.

This dust, when dispersed in the atmosphere, may be very harmful for human health, in particular for the workers at the manufacturing plant, if inhaled, resulting in a pulmonary disease called silicosis, which may also assume cancerogenic forms.

In order to overcome, at least partially, this drawback, a number of measures may be taken, in particular:
equipping the workers who are responsible for processing such articles with special individual protection devices, so-called IPD;
washing down with water the processing zone, in particular the zone where the machining tool comes into contact with the article; this measure prevents the dust containing crystalline silica from being dispersed in the air.
the provision of dust capturing equipment.

However, not always are these measures adopted, and therefore there is the need to manufacture an article which has the desired mechanical and/or chromatic properties, but which is able to avoid the formation and dispersion of dust containing silicon dioxide in crystalline form, which is harmful for the workers during the entire manufacturing process.

For example, WO2018/189663 discloses a method for the production of articles in slab or block form with a stone-like appearance which uses aggregates or fillers substantially devoid of silicon dioxide in crystalline form.

These synthetic aggregates or fillers may consist of a special amorphous glass, referred to in technical jargon as “frit”, which is very hard and semi-transparent, with an appearance similar to that of quartz; in these aggregates or fillers, the silicon dioxide in crystalline form may be present only in traces, i.e. in amounts of less than 1%.

The method for the production of these aggregates and fillers initially involves melting a mixture of selected natural minerals; then the molten material is cooled rapidly, normally with water (using a process known as “fritting”), dried, ground and separated into the desired granulometric fractions.

The aggregates and fillers thus produced have a hardness equal to or greater than 5 Mohs and may form at least 70% of the overall weight of the mixture.

This solution, although widely adopted in the sector, is not without a number of drawbacks. The main drawback of this solution consists in the fact that it is not possible to obtain in a low cost manner and without harmful effects for human health articles with a deep white colour, comparable to the white colour of particular high-quality white marble, using the aggregates and the fillers obtained with the method described above.

This drawback arises from the fact the aggregates and the fillers thus obtained in general have a semi-transparent and not opaque white appearance.

Therefore, the articles obtained using the aggregates and fillers described above may have various colours, depending on the colouring agent added to the mixture, but not the deep white colour, which is particularly in demand in the market.

In fact, in order to obtain a deep white colour of the articles, the aggregates and fillers must be opaque and have a deep white colour with L≥95, where L indicates the luminosity or brightness.

In order to provide the aggregates and fillers with the desired opacity and white colour, it would be necessary to produce the aggregates and fillers by adding zirconium oxide or fluorine, in particular in the form of fluorite, to the material forming the aggregates and the fillers. In fact, zirconium oxide and fluorite are known as whitening agents in the sector. However, these techniques are not without drawbacks.

In fact, zirconium oxide, which is present in the form of a pigmented white powder, must be added to the mixture in particularly large amounts, equal to about 10%, in order to obtain the desired deep white colour.

In this connection, it must be considered that zirconium oxide has a very high cost, so that its use would result in a significant increase in the overall production costs and therefore cost of the final article.

Fluorine instead has the drawback that it is particularly toxic and harmful for human health and has an aggressive action on machine structures and therefore its use is subject to particularly severe regulations.

Another drawback of fluorine consists in the fact that it would be released during the melting process and would cause deterioration of the refractory lining of the furnace for melting the minerals.

This drawback would therefore result in the need to take frequent action within the production plant in order to replace the refractory materials of the melting furnace, with a consequent substantial increase in the production costs.

The object of the present invention is to solve substantially the drawbacks of the prior art and overcome the known limitations, namely to produce articles which have an opaque deep white colour, avoiding in particular the use of cristobalite; in fact cristobalite, if pulverized and inhaled, is harmful for human health in the same way as quartz.

A particular task of the present invention is to provide a method for the production of granulate materials having a content of silicon dioxide in crystalline form equal to less 1% and suitable for being used for the production of articles in slab or block form, wherein the method avoids the formation of crystalline silicon dioxide dust during the article production and processing operations.

A further task of the present invention is to provide a method of the aforementioned type which allows the production of aggregates and fillers in the form of granulate materials having an opaque, deep white colour, which give the articles to which they are added a white colour, in particular with L≥95.

Another task of the present invention is to provide a method of the aforementioned type which does not require the addition of large quantities of zirconium oxide or fluorine for production of the white-coloured fillers and aggregates.

A further task of the present invention is to provide a method of the aforementioned type which is particularly simple and is low-cost.

Another task of the present invention is to provide a plant for the production of granulate materials which implements the aforementioned method.

A further task of the present invention is to provide a plant which is able to obtain granulate materials with uniform characteristics for each production process.

Another task of the present invention is to provide a plant which reduces the processing times necessary for production of the granulate materials.

The aforementioned object and tasks are achieved with a method and a plant for the production of granulate materials having a content of silicon dioxide in crystalline form of less 1% and suitable for being used as opaque white-coloured aggregates and fillers for the manufacture of articles in form of slab or block, in accordance with claims 1 and 14, respectively.

In order to illustrate more clearly the innovative principles of the present invention and its advantages compared to the prior art, an example of embodiment will be described below with the aid of the accompanying drawings. In the drawings:

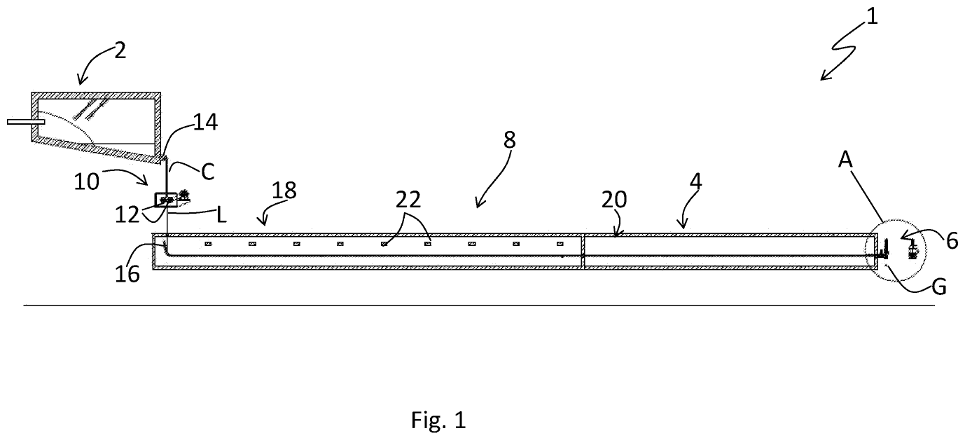

FIG. 1 shows a cross-sectioned side view of a plant for the production of granulate materials in accordance with the present invention in a first embodiment;

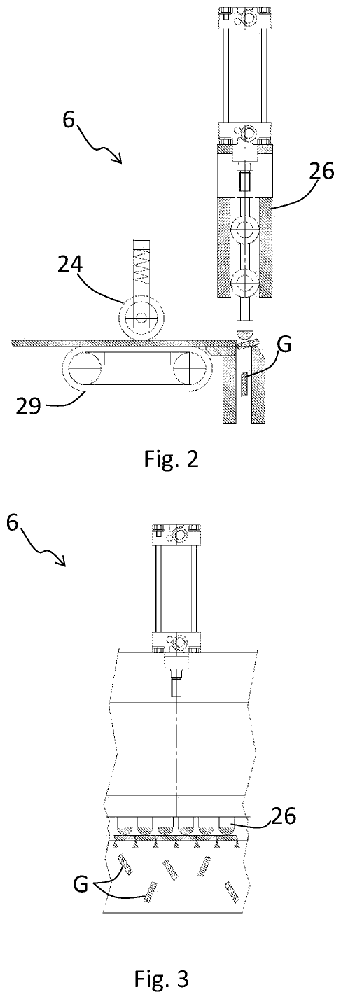

FIGS. 2 and 3 show, respectively, a side view and a front view, on a larger scale, of a detail of the plant indicated by “A” in FIG. 1;

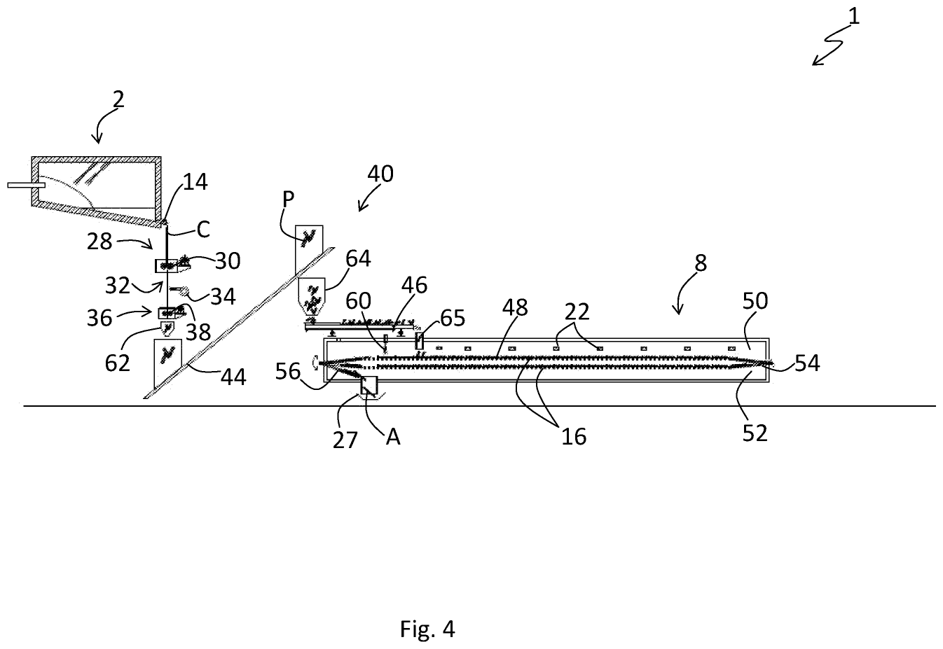

FIG. 4 shows a cross-sectioned side view of a plant for the production of granulate materials in accordance with the present invention in a second embodiment;

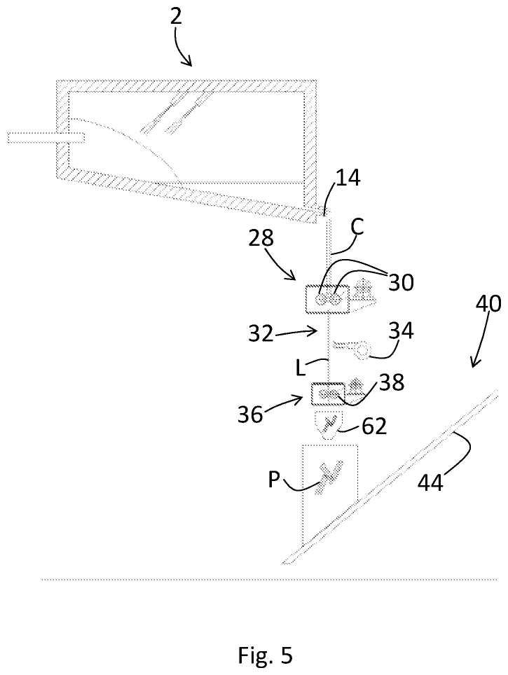

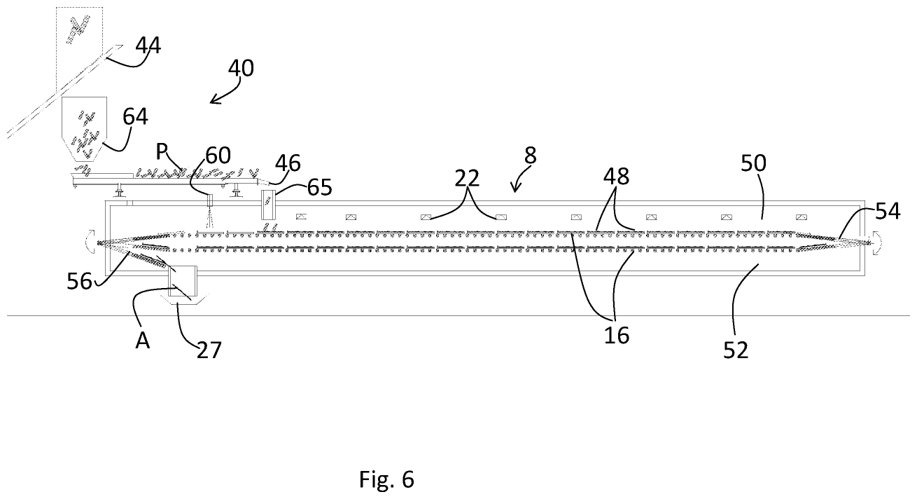

FIGS. 5 and 6 show side views, on a larger scale, of a first and second part of the plant according to FIG. 4;

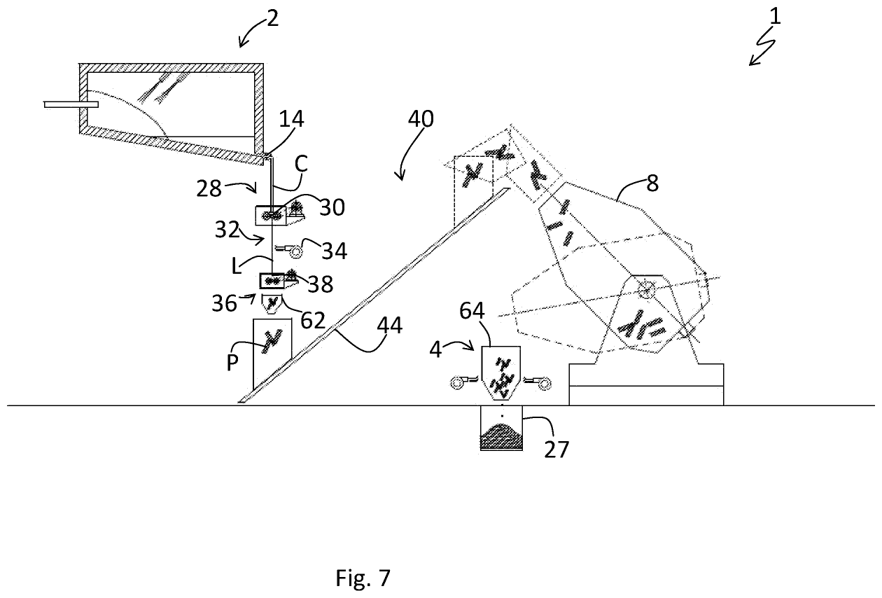

FIG. 7 shows a cross-sectioned side view of a plant for the production of granulate materials in accordance with the present invention in a third embodiment;

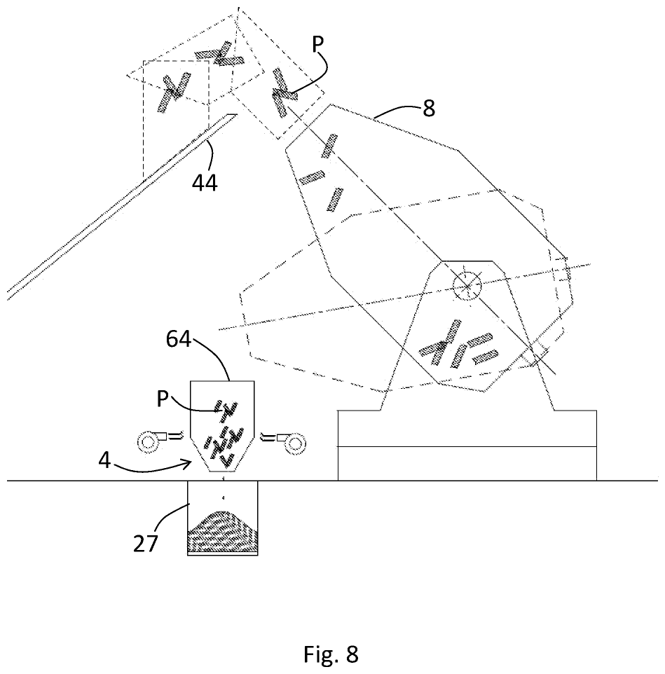

FIG. 8 shows a side view, on a larger scale, of a part of the plant according to FIG. 7;

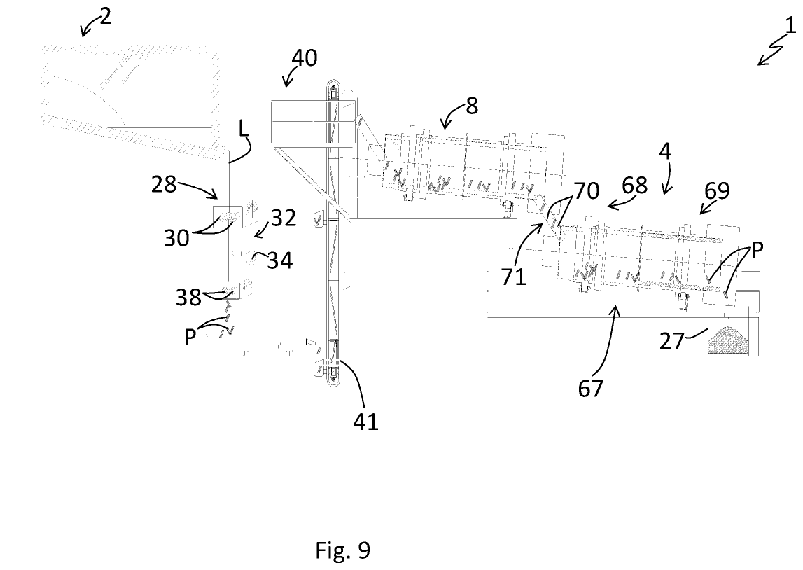

FIG. 9 shows a cross-sectioned side view of a plant for the production of granulate materials in accordance with a fourth embodiment.

With reference to the attached figures, a plant for the production of granulate materials suitable for being used for the manufacture of articles in slab or block from a mixture is described. In particular the plant is denoted overall by the reference number 1.

The plant 1 implements a method, also described below, for the production of granulate materials suitable for being used for the manufacture of articles in slab or block form from a mixture.

The granulate materials are suitable for being used preferably as aggregates and fillers in a mixture for manufacturing the articles in slab or block form.

In addition to the aggregates and/or fillers, the mixture for manufacturing the articles comprises a hardening binder. The binder may be of both the organic and inorganic type, as known from the prior art, and is suitable for being mixed with the fillers in order to obtain a binding paste.

The mixture may also comprise additives and colouring agents for obtaining articles which have special aesthetic effects, for example veining.

The method involves in particular providing a material for grinding so as to obtain the aggregates and the fillers from a particular mixture of minerals having a specific chemical composition.

The material of the aggregates and the fillers thus obtained is opaque and has an “absolute” white colour, preferably with L≥95. These characteristics are obtained by means of a step involving—at least partial—recrystallization of the material described below and performed after a step involving melting and casting of the mineral mixture.

By means of the recrystallization step it is possible to whiten completely the material of the aggregates and fillers and obtain a deep white colour of the aggregates and fillers.

The mixture of minerals has a specific chemical composition which promotes whitening or causes complete whitening of the material of the aggregates and fillers during the recrystallization step.

Below an example of the range of chemical compositions of the various components of the mixture is shown:
62%<SiO₂<70%;
16%<CaO<30%;
0.5%<MgO<6%;
2%<Al₂O₃<7%;
1%<K₂O<7%;
0.3%<Na₂O<1.5%.

Optionally the mixture may also contain oxides in the following weight ranges:
0%<ZrO₂<2%;
0%<B₂O₃<3%;
0%<ZnO<3%;
0%<BaO<3%;
0%<Li₂O<2%;
0%<P₂O₅<2%.

It is pointed out that any weight amount indicated above of zirconium oxide added to the mixture, however small, in this case does not have the function of a pigmentation agent, but that of a nucleating agent for favouring the recrystallization process.

One or more chromophores may also be present in the mixture. However, in order to obtain an opaque deep-white colour after the recrystallization step, the quantity of chromophores must be particularly small so that the aforementioned chemical composition may also comprise the following weight amounts:
Fe₂O₃<0.1%;
TiO₂<0.1%.

The aforementioned ranges are to be understood as weight amounts with respect to the overall weight of the mineral mixture.

In the preferred embodiment, the finished articles are obtained by means of vacuum vibrocompression of the mixture containing the binder, the aggregates and/or the fillers, in the manner known from the prior art.

The attached FIGS. 1-9 show four different embodiments of the plant 1 for the production of the aggregates and the fillers; these embodiments will be described more clearly below with particular reference to the different modes of implementation of the method for the production of the aggregates and the fillers.

In a preferred embodiment of the invention, the method comprises the following steps:

a) melting a suitably formulated mixture of selected minerals having a specific chemical composition so as to obtain a molten material C suitable for being cast and, and casting thereof;

c) cooling the molten and cast material to a predetermined temperature;

d) crushing and/or grinding the material to obtain granules of material having a selected grain size and suitable for being used respectively as aggregates and fillers in the mixture and for manufacturing the articles in slab or block form.

According to a particular aspect of the invention, the method involves, downstream of the melting and casting step a), a step b) for keeping the material at a predetermined temperature, preferably between 1030-1170° C., for a predetermined time period of at least 15 minutes.

During this step b) of keeping the material within the temperature range of between 1030-1170° C. for a predetermined time period the step of at least partial recrystallization of the material, starting from a substantially amorphous configuration, is performed.

In fact, after the melting step a), the material obtained from the mixture of molten minerals has an amorphous configuration.

The aggregates and the fillers obtained by means of the method according to the present invention, as a result in particular of the aforementioned step b) and therefore recrystallization of the material, are white and opaque and consist of calcium silicates which are substantially free from silicon dioxide in crystalline form.

The silicon dioxide which may be present is almost entirely in amorphous form.

The expression “substantially free from silicon dioxide in crystalline form” is understood as meaning that the silicon dioxide in crystalline form could optionally be present only in traces and in any case in amounts of less than 1% by weight of the overall weight.

The recrystallization step is performed in at least partial manner since the crystalline component of calcium silicates (but not silicon dioxide) may be equal to about 70-75%.

The aggregates and the fillers obtained by means of the method according to the present invention have an opaque deep-white colour such as to allow the manufacture of articles which have a white colour with a value L 95.

Moreover, the material of the aggregates and fillers thus obtained has an appearance similar to that of cristobalite and a hardness equal to or greater than 5 Mohs. The articles obtained from these aggregates and fillers also have the advantage of preventing the formation of cristobalite dust during processing thereof.

The method preferably involves, downstream of the melting and casting step a) and upstream of step b) for keeping the cast material within the predetermined temperature range, an intermediate step a1) for controlled cooling down to a predetermined temperature, separate from the cooling step c), and optionally a rolling step a2).

The predetermined cooling temperature following the intermediate step a1) must in any case be higher than the recrystallization temperature.

In a first mode of implementation of the method, the intermediate cooling step a1) consists in a first air cooling immediately after melting and casting of the mineral mixture so as to bring the molten material to a temperature close to 1300° C.

Moreover, this mode of implementation of the method involves the casting C of molten material being subjected to a rolling step a2 after the step a1) so as to form a sheet L which then undergoes the keeping and recrystallization step b) within the temperature range indicated.

Advantageously, the sheet of material has a maximum thickness not greater than 6 mm, preferably between 1 mm and 5 mm, and a temperature close to 1.200° C.

During this step of the method the sheet has an amorphous configuration and the temperature to which it is cooled is suitable for providing the sheet with a paste-like consistency so that the sheet may be placed on suitable feeding means, described below with reference to the plant.

Conveniently, the predetermined at least partial recrystallization time, namely time for keeping the sheet of material within the predetermined temperature range, preferably of between 1030° C. and 1170° C., is at least 15 minutes, preferably between 15 and 25 minutes.

It has been noted that surprisingly this time range, in combination with the temperature range indicated to allow recrystallization, helps whiten completely the sheet L of material and therefore the aggregates and the fillers obtained following crushing and/or grinding of the sheet.

This first mode of implementation of the method is carried out by means of a plant of the type shown in FIGS. 1 to 3.

This plant 1 comprises a furnace 2 for melting the mixture of selected natural minerals having a specific chemical composition of the type indicated above, so as to obtain a casting of molten material C, means 4 for cooling the material and means for crushing and/or grinding the material supplied by the cooling means 4.

FIGS. 1-3 show only the crushing means which allow shards G of material to be obtained, these being then intended to be ground using a separate plant.

In particular, the shards G may be ground with selected grain sizes so as to produce granulate materials which may be selectively used as aggregates or fillers.

Conveniently, the mixture of selected minerals, which have the desired chemical composition, is introduced inside the melting furnace 2 by means of a feeder screw (not shown in the figures) and the melting temperature of the minerals inside the melting furnace 2 is between 1500° C. and 1600° C.

In accordance with the said particular aspect of the invention, the plant comprises a holding furnace 8 for keeping the molten material at a temperature of between 1030° C. and 1170° C. and designed to perform the keeping and recrystallization step b) of the aforementioned method.

Conveniently the holding furnace 8 is positioned upstream of the cooling means 4 and the crushing means 6.

Moreover, the step a2) of rolling the material is performed by means of a rolling mill 10 comprising two rotating rolls 12, as shown in FIG. 1.

The melting furnace 2 comprises an outlet mouth 14 and the rolling mill 10 is positioned below the outlet mouth 14.

In particular, the rolls 12 of the rolling mill 10 are vertically aligned with the outlet mouth 14 and their axes of rotation are horizontal.

Preferably, the rolls 12 are rotatable with an opposite direction of rotation and each of them is motor-driven. One of the rolls may be fixed, while the other roll is adjustable so as to vary the distance between the two rolls 12.

In this embodiment of the plant, the intermediate step a1) of cooling the casting C is performed during the passage of the molten material from the melting furnace 2 to the rolls 12 of the rolling mill 10. Therefore it is the air present in the environment between the melting furnace 2 and the rolling mill 10 which cools the casting C directed towards the holding furnace 8.

In an alternative embodiment (not shown in the figures), the plant according to FIG. 1 may have one or more jets arranged between the melting furnace 2 and the rolling mill 10 for cooling the casting of material C.

As indicated above, the sheet of material output from the rolling mill 10 has a maximum thickness not greater than 6 mm, preferably between 1 mm and 5 mm, and a temperature close to 1200° C.

At this temperature the sheet L has a paste-like consistency such that it may be suitably shaped and conveyed inside the holding furnace 8.

It has been noted that by keeping the thickness of the sheet below 6 mm it is possible to obtain, by means of the temperatures and the times indicated for step b), complete and uniform whitening of the sheet L and therefore of the aggregates and the fillers which will be produced following crushing and subsequent grinding of the sheet L.

At this point, the cooled and rolled material is transferred into the holding furnace 8. For this purpose, the holding furnace 8 comprises a series of motor-driven rollers 16—shown in FIG. 1—arranged to form a chute or a curved section at the inlet of the holding furnace 8 so that the sheet L assumes a horizontal position from a vertical position.

Inside the holding furnace 8 the motor-driven rollers 16 form a horizontal surface for feeding the sheet L.

Furthermore, in this embodiment of the plant 1, the holding furnace 8 comprises a first section 18 positioned upstream, in which the material is kept within the temperature range 1030° C.-1170° C. for a predetermined time, namely 15-25 minutes, so as to perform the step b) of keeping the material at a predefined temperature.

A second section 20 is also provided, positioned downstream, for rapidly cooling the material, so as to perform the step c) of cooling the material to a predetermined temperature such as to give the sheet L a rigidity suitable for being subsequently broken up into shards G.

Therefore the second section 20 forms the cooling means 4 of the plant 1 in the embodiment and may comprise devices known in the sector for cooling the material.

The parts of the plant 1 described above are shown in detail in FIG. 1 where the first section 18 of the holding furnace 8 comprises a series of burners 22 for keeping the material within the predefined temperature range, namely 1030-1170° C.

The means 6 for crushing the sheet L, shown more clearly in FIGS. 2 and 3, are positioned downstream of the holding furnace 8, in particular downstream of the second section 20 and therefore downstream of the cooling means 4.

These cooling means 6 may comprise a series of cutting discs 24 for cutting longitudinal strips of material along the sheet L and a blade 26 with a plurality of cutting edges designed to strike intermittently the material cut into strips so as to break it up into shards G.

Moreover a support belt 29 wound around two rollers and positioned underneath the cutting discs 24 may be provided, as clearly shown in FIG. 2, so as to act as an anvil and oppose the forces generated by the cutting discs 24.

The material thus broken up is stored in a storage station (not shown in this embodiment) so that it may be used subsequently, after cooling to room temperature and grinding, as an aggregate or filler for manufacturing the articles, depending on the selected grain size.

The second embodiment of the plant 1 shown in FIGS. 4 to 6 is used to implement a second mode of implementation of the method for the production of the granulate materials. In this embodiment of the plant 1, the intermediate step a1) for performing cooling to a temperature lower than the recrystallization temperature is performed by means of the transit of the casting C of molten material output from the melting furnace 2 into a rolling mill 28 comprising cooled rolls 30 so as to obtain a sheet L, as illustrated more clearly in FIG. 5. It is worth noting that the step of casting molten material output from the melting furnace 2 is a continuous process.

In a manner similar to that described for the first embodiment, the sheet of material output from the rolling mill 28 has a maximum thickness not greater than 6 mm, preferably of between 1 mm and 5 mm, and an amorphous configuration.

It has been noted that by keeping the thickness of the sheet L below 6 mm it is possible to obtain, by means of the temperatures and the times indicated for step b), complete and uniform whitening of the sheet L and therefore the aggregates and the fillers which will be produced following crushing of the sheet L and subsequent grinding.

The cooled rolls 30 form means 32 for intermediate cooling of the material, being positioned downstream of the melting furnace 2 and upstream of the holding furnace 8. In this embodiment of the plant 1, the rolling step a2) and the intermediate cooling step a1) coincide substantially.

Moreover, the intermediate cooling means 32, in addition to the cooled rolls 30, may also comprise air jets 34 positioned at the outlet of the rolling mill 28.

In this case, the sheet L has, after rolling, a temperature of about 500-600° C. At this temperature the sheet L acquires a rigidity sufficient for it to be broken up into shards G.

In an alternative embodiment of the plant 1 (not shown in the figures), the means 32 for intermediate cooling of the material may comprise water jets located between the melting furnace 2 and the inlet of the holding furnace 8, and therefore the intermediate cooling step a1) may be performed with water until the material reaches room temperature.

In this case fritting of the molten material occurs, namely a material containing silicon dioxide in amorphous form, referred to in technical jargon as “frit”, is formed, said material having an appearance similar to that of quartz.

With reference to the embodiment described above, the plant 1 comprises means 36 for intermediate crushing of the molten and cooled material positioned downstream of the intermediate cooling means 32, namely cooled rolls 30 or water cooling means, and different from the crushing means 6 positioned at the outlet of the holding furnace 8 for performing the step d) indicated above and not shown in FIGS. 4 to 6.

These crushing means 36 therefore perform an intermediate crushing step downstream of the intermediate cooling step a1) and different from the step d) indicated above.

After the cooling and intermediate crushing, the fragments of material, following drying if they have been cooled in water, are introduced into the holding furnace 8, as indicated above. The larger aggregates formed during the intermediate crushing step must also be broken into fragments P with a maximum thickness of less than 6 mm; it has in fact been noted that by keeping the thickness of the fragments smaller than 6 mm, and preferably between 1 and 5 mm, it is possible to obtain, by means of the temperatures and the times indicated for step b), the complete and uniform whitening of the fragments P and therefore of the aggregates and fillers which will be produced following subsequent grinding.

In the embodiment of the plant shown in FIGS. 4 and 5, the crushing means 36 comprise a pair of motor-driven and counter-rotating crushing rolls 38 provided with hammers or cutters.

However, these intermediate crushing means 36 may also comprise elements or devices different from the crushing rolls, without thereby departing from the scope of protection of the present invention.

Advantageously, the crushing means 36 are designed to break up the sheet output from the rolling mill of the second embodiment of the plant 1.

The fragments P of crushed material are then moved towards the inlet, or supply opening, of the holding furnace 8 by means of suitable conveying means 40, shown more clearly in FIGS. 4-6. As can be seen from the figures, these conveying means are not present in the first embodiment of the plant described above, where the sheet L of the material is introduced into the holding furnace 8.

These conveying means 40 may comprise an elevator 44 positioned underneath the crushing rolls 38 and provided with an insulated conveyor carriage, for preventing the material from cooling, and a suitably heated vibrating conveyor belt 46, the terminal end of which is located at the supply opening of the holding furnace 8.

Alternatively, according to an embodiment (not shown in the figures), the conveying means 40 may comprise a further conveyor belt positioned between the crushing rolls 38 and the elevator 44.

Moreover, the elevator 44 may also be heated so as to take advantage of the step for conveying the fragments P of material in order to increase the temperature and therefore reduce the subsequent heating time which occurs inside the holding furnace 8, thereby reducing the overall production time.

As shown in FIGS. 4-6, suitably insulated buffer hoppers 62, 64 may also be provided, these being designed to allow storage of the fragments P of material and avoid cooling thereof.

This measure is necessary since the transfer of the fragments P by means of the elevator 44 occurs at regular intervals and not continuously, like the casting of the molten material. Moreover, this measure favours the progressive and gradual unloading of the fragments P onto the vibrating conveyor belt 46.

In particular, a loading buffer hopper 62 positioned at the inlet of the elevator 44, preferably between the crushing rolls 38 and the elevator 44, and an unloading buffer hopper 64 positioned at the outlet of the elevator 44, preferably between the elevator 44 and the vibrating conveyor belt 46, are provided.

Advantageously, the loading capacity of the buffer hoppers 62, 64 must be at least equal to the quantity of fragments P produced within the time period necessary for the outward and return travel of the carriage of the elevator 44.

Alternatively, according to an embodiment (not shown in the figures), it is possible to consider removing the elevator 44 from the plant 1 and positioning the holding furnace 8 immediately downstream of the unloading hopper 64.

The fragments P of crushed material, after being moved to the holding furnace 8 by the conveying means 40, are distributed inside supports 48, shown more clearly in FIGS. 4 and 6, which are movable along feeding means of the holding furnace 8. The latter comprise preferably one or more surfaces with rollers 16, as shown more clearly in FIG. 6.

Moreover, the fragments P of material may be distributed by the vibrating conveyor belt 46 to the supports 48 by means of a conveyor 65, shown more clearly in FIGS. 4 and 6.

In a manner known per se, the supports 48 may be made of refractory material and may comprise a layer of slip having the function of a release agent.

For this purpose, the holding furnace 8 comprises a sprayer 60 for spraying a releasing slip onto the empty support 48, shown in FIGS. 4 and 6, before it is filled with the fragments P of material supplied by the conveying means 40.

Preferably, the layer of crushed material distributed inside the supports 48 has a thickness of between 5 mm and 20 mm.

In a manner similar to that described above, these embodiments of the plant with the cooled rolls 30 or with the water cooling means also have a holding furnace 8 comprising two sections, namely a first section 50 and a second section 52.

As shown in FIGS. 4 and 6, the first section 50 upstream of the holding furnace 8 comprises a series of burners 22 for heating the fragments P of fragmented material to a temperature of between 1030° C. and 1170° C. (respectively from 500-600° C. and from room temperature, as indicated above) in order to perform the recrystallization of the material, while the second section 52 is designed to keep the heated material within the predetermined temperature range.

Conveniently the two sections may be positioned above one another, as shown in FIGS. 4 and 6, and a first deviating element 54, a second deviating element 56 and a respective roller surface 16 for each section 50, 52 are provided; the supports 48 advance on the roller surfaces 16 of the two sections 50, 52 in directions opposite to each other.

The first deviating element 54 is designed to be inclined downwards in order to transfer the supports 48 containing the crushed material from the first section 50, situated above, to the second section 52, positioned underneath, while the second deviating element 56 is designed to transfer an agglomerate A of the crushed material to a storage station 27 positioned at the outlet of the holding furnace 8, as shown in FIGS. 4 and 6.

In particular, the agglomerate A is formed following the passage of the support 48 with the crushed material in the first section 50 and in the second section 52 of the holding furnace 8 and is composed of recrystallized fragments P.

Advantageously, the second deviating element 56 is designed to be inclined downwards in order to cause the agglomerate A of crushed material to be slide from the respective support 48 at the end of the feed path along the second section 52 and is designed to be inclined upwards to allow the empty support 48 to be again displaced into the first section 50 of the holding furnace 8 in order to receive further crushed material from the conveying means 40.

The roller surfaces 16 of the sections 50, 52 of the holding furnace 8 and the deviating elements 54, 56 are connected to a control unit, not shown in the figures, so as to keep the material inside the holding furnace 8 for the predetermined time period of at least 15 minutes and preferably between 15 and 25 minutes.

At the outlet of the holding furnace 8, the fragments of material, namely the agglomerate A, are subjected to further cooling steps down to room temperature and to the subsequent grinding by means of cooling and crushing/grinding means, not shown in FIGS. 4-6, so as to perform the steps c) and d) of the method indicated above.

FIGS. 7 and 8 show a third embodiment of the plant used to implement the second mode of implementation of the method for the production of the granulate materials, described above, using an alternative technique.

This latter embodiment represents a variation of the second embodiment of the plant 1 described above and illustrated in FIGS. 4 to 6.

In this third embodiment of the plant 1, the first part of the plant as far as the elevator 44 remains unvaried compared to that described for the second embodiment. In particular, in this embodiment also, a loading buffer hopper 62 is provided between the crushing rolls 38 and the elevator 44.

The fragments P of material, after being moved by the elevator 44, are distributed inside a rotary furnace which heats the fragments up to a temperature of about 1030-1170° C.

This furnace therefore constitutes the holding furnace 8 and in this embodiment is a rotating, tilting, discontinuously operating (batch) furnace.

The fragments P are heated in this holding furnace 8 up to a temperature of about 1030-1170° C. and then kept at the same temperature for a time period of about 15-25 minutes so as to perform the, at least partial, recrystallization of the material.

This furnace 8 is also provided with burners and its rotation is necessary in order to maintain a uniform temperature of the fragments P of material inside the furnace 8.

At the end of the keeping step b), the fragments P, by means of rotation and/or inclination of the furnace downwards (as indicated in FIGS. 7 and 8 by means of broken lines), are discharged into an unloading buffer hopper 64, similar to that described above for the second embodiment. It is pointed out, however, that the arrangement of the two unloading buffer hoppers 64 varies between the two embodiments.

In this latter embodiment, the unloading hopper 64 may be provided with coolers which may be of the air or also water type, as shown in FIGS. 7 and 8; water cooling is preferable since it allows lowering of the temperature down to 200° C. Therefore, the unloading buffer hopper 64 may constitute the cooling means 4 indicated above for performing the step c) of the method.

At the outlet of the holding furnace 8, the fragments P of material unloaded may be stored in a storage station 27 or unloaded onto a conveyor belt. Then they are subject to further cooling steps down to room temperature and to subsequent grinding via cooling and crushing/grinding means, respectively, so as to complete step c) and perform step d) of the method.

FIG. 9 shows a fourth embodiment of the plant 1 which implements the second mode of implementation of the method for production of granulate materials; this fourth embodiment is an alternative to the third embodiment.

This embodiment of the plant 1 operates continuously and does not comprise loading and unloading buffer hoppers, unlike the third embodiment of the plant.

Moreover, the fourth embodiment of the plant comprises, in a manner similar to the third embodiment, the melting furnace 2, the intermediate cooling means 32 with the cooled rolls 30 and the air jets 34, the crushing rolls 38 and the conveying means 40.

However, the conveying means 40 of the fourth embodiment for moving the fragments P towards the holding furnace 8 comprise a bucket elevator 41 which continuously feeds the holding furnace 8.

Advantageously, the bucket elevator 41 works stepwise, positioning a bucket so as to be filled with the fragments P of material, preferably every two minutes.

The conveying means 40 may also comprise a vibrating channel or surface 45 arranged between the crushing rolls 38 and the bucket elevator 41; the vibrating channel or surface 45 may be slightly inclined so as to convey the fragments P inside the buckets of the elevator 41. The holding furnace 8 of the fourth embodiment of the plant is a rotating, inclined, continuously operating furnace, as illustrated more clearly in FIG. 9.

In particular, the holding furnace 8 consists of a cylinder rotating about its longitudinal axis and provided with one or more burners 22. The rotation of the cylinder about the longitudinal axis allows the fragments P to be kept at a uniform temperature.

Moreover, as already indicated above, this holding furnace 8 has a predetermined inclination with respect to the ground; this inclination may be fixed or variable.

In the case of a variable inclination, the holding furnace 8 is rotatable by a limited amount also about a transverse axis passing through the centre of the holding furnace 8.

The predetermined inclination of the holding furnace 8 favours the feeding of the fragments P towards the cooling means 4 positioned downstream; moreover the selection of the predetermined inclination determines the transit time of the fragments P inside the holding furnace 8 and therefore the duration of the keeping step b).

In particular, in this embodiment, the holding furnace 8 is designed to keep the fragments P of material at a temperature preferably close to 1100° C. and for a time period of at least 15 minutes and preferably close to 20 minutes.

Advantageously it is possible to adjust the duration and the working conditions during the keeping step b) by regulating three different parameters, namely:
the speed of rotation of the holding furnace 8 about the longitudinal axis;
the inclination of the holding furnace 8;
the power of the burners 22.

Moreover, the cooling means 4 comprise a cooling device 67 located downstream of the holding furnace 8.

The cooling device 67 is also formed by a cylinder having a predetermined inclination fixed or variable with respect to the ground so as to allow feeding of the fragments P towards the grinding means, not shown in FIG. 9.

Moreover, the cooling device 67 oscillates or tilts about its longitudinal axis; in this way the cooling device 67 may be made to oscillate about the longitudinal axis with a predetermined angle, preferably close to 135° on one side and on the other side.

The cooling device 67 may also be divided up into an upstream section 68 and a downstream section 69; the upstream section 68 is located in the vicinity of the holding furnace 8.

The upstream section 68 comprises one or more atomizer nozzles 70 positioned preferably opposite the channel 71 for conveying the fragments P.

The conveying channel 71 is arranged between the holding furnace 8 and the cooling device 67 so as to allow the fragments P to pass from the holding furnace 8 to the cooling device 67. The atomizer nozzles 70 inject atomized air onto the fragments P being fed so as to lower the temperature of the material from 1100° C. to 200° C. and keep a relative humidity value of the fragments P less than 3%.

Moreover the upstream section 68 of the cooling device 67 is made with a material able to withstand the initial temperature of the fragments P output from the holding furnace 8, equal to 1100° C.

The downstream section 69 of the cooling device 67 comprises a plurality of ducts inside which water for further cooling the fragments P, in this case mainly by means of convection, down to a temperature of about 50° C., flows.

The cooled fragments P output from the downstream section 69 may be stored in a storage station 27, as shown in FIG. 9, before being ground.

The above description therefore clearly highlights the advantages which may be obtained compared to the conventional methods for the production of aggregates and fillers suitable for being used for the manufacture of articles in slab or block form from a mixture.

Firstly, the aggregates and the fillers obtained by means of the method and the plant of the present invention substantially do not contain silicon dioxide in crystalline form; in this way, the formation and dispersion, during the manufacture of the articles obtained from the aforementioned aggregates and fillers, of dust containing silicon dioxide in crystalline form, for example cristobalite, with harmful effects for human health is avoided.

At the same time, the aggregates and the fillers obtained by means of the method and the plant according to the present invention have an opaque deep-white colour and are able to give also the articles an opaque deep-white colour with a value L≥95.

Therefore, the articles obtained from these aggregates and fillers have an aesthetic appearance very similar to that of articles made of high-quality white marble.

Moreover, by means of these aggregates and fillers, it is possible to obtain an article with aesthetic, mechanical and performance characteristics very similar to those made using cristobalite, which is currently widely used and popular on the market.

The person skilled in the art, in order to satisfy specific needs, may make modifications to the embodiments described above and/or replace the elements described with equivalent elements, without thereby departing from the scope of the attached claims.

1. Method for manufacturing granulate materials designed to be used as aggregates and fillers for manufacturing articles in form of slab or block from a mixture containing a binder, comprising the steps of:
a) melting a mixture of selected minerals having a specific chemical composition for obtaining a casting (C) of molten material and casting of the material;
c) cooling the cast material to a predetermined temperature;
d) crushing and/or grinding the material so as to obtain granules having a selected grain size and suitable for being used respectively as aggregates or fillers in the mixture for manufacturing the articles in form of slab or block;
characterized in that it comprises, downstream of said melting and casting step a), a step b) of keeping the molten and cast material at a predetermined temperature, ranging between 1030-1170° C., for a predetermined time period of at least 15 minutes;
and in that said aggregates and fillers have a content of silicon dioxide in crystalline form of less than 1%.

2. Method according to claim 1, characterized in that, downstream of said melting and casting step a) and upstream of said step b) for keeping the material at a predetermined temperature, there is an intermediate step a1) of controlled cooling of the molten and cast material down to a predetermined temperature, independent of said cooling step c).

3. Method according to claim 2, characterized in that, following said intermediate cooling step a1), the material has a temperature close to 1300° C.

4. Method according to any one of the preceding claims, characterized in that, upstream of said step b) for keeping the material at a predetermined temperature, a rolling step a2) is provided, with further cooling of the molten and cast material so as to form a sheet, said sheet having a maximum thickness not greater than 6 mm.

5. Method according to claim 4, characterized in that, downstream of said rolling step a2), a step, different from said step d), for the intermediate crushing of the rolled material in order to obtain fragments with a maximum thickness of not more than 6 mm, is provided.

6. Method according to claim 5, characterized in that said intermediate cooling step a1) is performed by means of air jets and during said step a2) for rolling the molten and cast material by means of transit of the molten material casting through a rolling mill comprising cooled rolls.

7. Method according to claim 2, characterized in that, downstream of said intermediate cooling step a1), a step for the intermediate crushing of the material in order to obtain fragments with a maximum thickness of not more than 6 mm is provided.

8. Method according to claim 7, characterized in that said intermediate cooling step a1) is performed using water until the molten and cast material reaches room temperature.

9. Method according to claim 1, characterized in that, during said step b), the material is kept at a temperature of between 1030° C. and 1170° C. for a time period of between 15 and 25 minutes.

10. Method according to claim 1, characterized in that the material of said aggregates and fillers consists of calcium silicates free from silicon dioxide in crystalline form.

11. Method according to claim 1, characterized in that the specific composition of the mineral mixture comprises:
62%<SiO₂<70%;
16%<CaO<30%;
0.5%<MgO<6%;
2%<Al₂O₃<7%;
1%<K₂O<7%;
0.3%<Na₂O<1.5%.

12. Method according to claim 11, characterized in that the specific composition of said mixture of selected minerals comprises:
0%<ZrO₂<2%;
0%<B₂O₃<3%;
0%<ZnO<3%;
0%<BaO<3%;
0%<Li₂O<2%;
0%<P₂O₅<2%.

13. Method according to claim 12, characterized in that the specific composition of said mixture of selected minerals comprises:
Fe₂O₃<0.1%;
TiO₂<0.1%.

14. Plant (1) for manufacturing aggregates and fillers designed to be used for manufacturing articles in slab or block form from a mixture containing a binder, comprising:
a furnace (2) for melting a mixture of selected minerals having a specific chemical composition for producing a casting (C) of molten material;
means (4) for cooling the material;
means (6) for crushing and/or grinding the material output from said cooling means (4) so as to obtain granules suitable for being used respectively as aggregates or fillers in the mixture for manufacturing the articles in form of slab or block;
characterized in that it comprises a holding furnace (8) for keeping the molten and cast material at a temperature of between 1030° C. and 1170° C. for a predetermined time period, said holding furnace (8) being positioned downstream of said melting furnace (2) and upstream of said cooling means (4) and said crushing and/or grinding means (6).

15. Plant according to claim 14, characterized in that it comprises means (32) for intermediate cooling of the molten and cast material, positioned downstream of said melting furnace (2) and upstream of said holding furnace (8).

16. Plant according to claim 14, characterized in that said holding furnace (8) comprises a series of motor-driven rollers (16) arranged to form a chute at the inlet for introducing the molten material into said holding furnace (8).

17. Plant according to claim 15, characterized in that it comprises a rolling mill (10, 28) comprising two rotating rolls (12, 30) for rolling the molten and cast material and positioned downstream of said melting furnace (2).

18. Plant according to claim 17, characterized in that said rolls (30) are cooled and form said intermediate cooling means (32).

19. Plant according to claim 15, characterized in that it comprises, downstream of said melting furnace (2), means (36) for intermediate crushing of the cooled molten material into fragments (P) having a maximum thickness of not more than 6 mm.

20. Plant according to claim 19, characterized in that said intermediate crushing means (36) comprise a pair of motor-driven crushing rollers (38) provided with hammers or cutters.

21. Plant according to claim 19, characterized in that it comprises means (40) for conveying said fragments (P) of material from said crushing means (36) to the inlet of said holding furnace (8).

22. Plant according to claim 21, characterized in that, inside said holding furnace (8), the fragments (P) are distributed inside supports (48) movable along feeding means of the holding furnace (8).

23. Plant according to claim 22, characterized in that said holding furnace (8) comprises a first section (50) for heating the molten and cooled material to a temperature of between 1030° C. and 1170° C. and a second section (52) for keeping the heated material within said temperature range.

24. Plant according to claim 23, characterized in that the sections (50, 52) of said holding furnace (8) are positioned one above the other, there being provided a first deviating element (54) designed to be inclined downwards so as to transfer the supports (48) containing the fragments (P) from said firsts section (50) to said second section (52) and a second deviating element (56) designed to be inclined downwards so as to transfer an agglomerate (A) of the crushed material to a storage station (27).

25. Plant according to claim 14, characterized in that said holding furnace (8) is a rotating, tilting and discontinuously operating (batch) furnace (8).

26. Plant according to claim 14, characterized in that said holding furnace (8) is a rotating, inclined and continuously operating furnace (8).

27. Plant according to claim 26, characterized in that said cooling means (4) comprise a cooling device (67) positioned downstream of the holding furnace (8), said cooling device (67) being inclined and oscillating about its longitudinal axis.
